(19) United States
(12) Patent Application Publication
(10) Pub. No.: US 2021/0275989 A1
(43) Pub. Date: Sep. 9, 2021

(54) FUNCTIONAL MATERIALS AND DEVICES FOR REDUCING TOXIC POLLUTANTS

(71) Applicant: Performance Labs Pte. Ltd., Singapore (SG)

(72) Inventor: Daniel Gubler, Orem, UT (US)

(21) Appl. No.: 17/249,501

(22) Filed: Mar. 3, 2021

Related U.S. Application Data
(60) Provisional application No. 62/985,459, filed on Mar. 5, 2020.

(51) Int. Cl. B01J 20/22; B01J 20/28; B01J 20/34; B01J 20/32; A62B 23/02; A62B 17/00; A62D 3/33; A41B 1/08; A41D 13/11

(52) U.S. Cl. CPC B01J 20/223; B01J 20/28028; B01J 20/3475; B01J 20/3425; B01J 20/3208; A62D 2101/20; A62B 23/025; A62B 17/006; A62D 3/33; A41B 1/08; A41D 13/11; B01J 20/3265

(57) ABSTRACT

Provided herein are devices, systems, and methods for capturing toxic pollutants, such as polycyclic aromatic hydrocarbons. Certain embodiments of the present disclosure are related to a pollutant-absorbing material that includes an absorbent compound, such as sodium copper chlorophyllin, capable of binding to and capturing a toxic pollutant, and methods of making and using the material for the capture of toxic pollutants. The pollutant-absorbing material can be incorporated into an article worn by a person, such as a shirt or a facemask.

### INCORPORATION BY REFERENCE TO PRIORITY APPLICATION

This application claims priority to U.S. Provisional Application Ser. No. 62/985,459, filed Mar. 5, 2020, which is hereby incorporated herein by reference in its entirety.

### FIELD

The present disclosure relates to compositions, devices, systems, and methods for capturing pollutants, and thereby reducing an amount of pollutants. In particular, the present disclosure relates to clothing, masks, filters that reduce toxic airborne pollutants, such as polycyclic aromatic hydrocarbons.

### BACKGROUND

Air pollution is a major public health concern, particularly in densely populated cities or industrial areas. Air pollution commonly manifests in weather patterns such as smog or acid rain. Second hand smoke produced by combustion of tobacco products presents a local hazard. Air pollution directly promotes cardiovascular and respiratory diseases, and can trigger or exacerbate asthma and allergy attacks, and has been found to impair brain and lung development in children. Both urban air pollution and tobacco smoke share some common hazardous constituents, including polycyclic aromatic hydrocarbons, nitrogen dioxide, carbon monoxide and volatile organic compounds. Air pollution comprises several classes of toxic constituents.

Existing personal respiratory protection devices for ordinary use, such as face masks or air filters, are able to capture some components of air pollution, such as particulate matter by mechanical filtration, but do not prevent inhalation of other non-particulate toxic pollution components. There exists a need for personal protection device, including masks, clothing, or filters that absorb and thereby reduce non-particulate airborne pollutants.

### SUMMARY

Described herein are compositions, devices, systems, and methods for capturing pollutants, thereby reducing exposure to pollutants, or reducing an amount of pollutants in an environment. Compositions include materials, such as textile materials that comprise an absorbent compound capable of capturing pollutants. The textile materials can be prepared or configured as clothing, overwear, or filters. Certain embodiments are described further in the following description, examples, claims, and drawings.

Some embodiments provided herein relate to pollutant-absorbing compositions. In some embodiments, the compositions include a textile material and an absorbent compound. In some embodiments, the compositions capture a toxic pollutant. In some embodiments, the textile material comprises cotton, rayon, silk, flax, hemp, bamboo, polyester, nylon, or wool, or a combination thereof. In some embodiments, the textile material is configured as a mask, a shirt, an overcoat, a hat, a linen, gloves, or an air filter. In some embodiments, the absorbent compound is sodium copper chlorophyllin (SCC). In some embodiments, the absorbent compound is present in an amount ranging from 2 μmol to 30 μmol of absorbent compound per gram of textile material. In some embodiments, absorbent compound is present in an amount ranging from 50 to 500 nmol of absorbent compound per cm² of textile material. In some embodiments, the absorbent compound is present in an amount of 1 gram to 20 grams. In some embodiments, the toxic pollutant comprises an airborne pollutant. In some embodiments, the toxic pollutant comprises a polycyclic aromatic hydrocarbon (PAH). In some embodiments, the toxic pollutant comprises benzo[a]pyrene, benzo[e]pyrene, or combinations thereof. In some embodiments, the composition is washable. In some embodiments, the composition retains the absorbent compound after washing.

Some embodiments provided herein relate to methods of capturing a toxic pollutant. In some embodiments, the methods include providing a pollutant-absorbing composition as described herein and contacting the composition with a toxic pollutant. In some embodiments, the toxic pollutant comprises a polycyclic aromatic hydrocarbon (PAH). In some embodiments, the toxic pollutant is benzo[a]pyrene. In some embodiments, the composition binds to the toxic pollutant in an amount ranging from 0.2 to 10 nmol of pollutant. In some embodiments, the method further includes washing the pollutant-absorbing composition after capturing the toxic pollutant, thereby removing the toxic pollutant and regenerating the pollutant-absorbing composition.

Some embodiments provided herein relate to methods of making a pollutant-absorbing composition as described herein. In some embodiments, the methods include providing a textile material and contacting the textile material with an absorbent compound. In some embodiments, the absorbent compound is present in an amount ranging from 0.1 to 1 mg/mL. In some embodiments, the contacting is performed for a period of time ranging from 1 to 20 hours at a temperature ranging from 45 to 70° C.

Some embodiments provided herein relate to articles of clothing that include the compositions described herein. In some embodiments, the articles of clothing comprises a shirt or a facemask. In some embodiments, the article of clothing includes, is manufactured from, or incorporates any one or more of the compositions described herein. For example, the article of clothing includes, is manufacture from, or incorporates a composition including a textile material and an absorbent compound. In some embodiments, article of clothing incorporating the compositions capture a toxic pollutant. In some embodiments, the textile material comprises cotton, rayon, silk, flax, hemp, bamboo, polyester, nylon, or wool, or a combination thereof. In some embodiments, the article of clothing is configured as a mask, a shirt, an overcoat, a hat, a linen, or gloves. In some embodiments, the absorbent compound is sodium copper chlorophyllin (SCC). In some embodiments, the absorbent compound is present in an amount ranging from 2 μmol to 30 μmol of absorbent compound per gram of textile material. In some embodiments, absorbent compound is present in an amount ranging from 50 to 500 nmol of absorbent compound per cm² of textile material. In some embodiments, the absorbent compound is present in an amount of 1 gram to 20 grams. In some embodiments, the toxic pollutant comprises an airborne pollutant. In some embodiments, the toxic pollutant comprises a polycyclic aromatic hydrocarbon (PAH). In some embodiments, the toxic pollutant comprises benzo[a]pyrene, benzo[e]pyrene, or combinations thereof. In some embodiments, the article of clothing is washable. In some embodiments, the article of clothing retains the absorbent compound after washing.

Accordingly, some embodiments are described herein with reference to the following enumerated alternatives:

1. A pollutant-absorbing composition comprising a textile material and an absorbent compound, wherein the composition captures a toxic pollutant.

2. The composition of alternative 1, wherein the textile material comprises cotton, rayon, silk, flax, hemp, bamboo, polyester, nylon, or wool, or a combination thereof.

3. The composition of any one of alternatives 1-2, wherein the textile material is configured as a mask, a shirt, an overcoat, a hat, a linen, gloves, or an air filter.

4. The composition of any one of alternatives 1-3, wherein the absorbent compound is sodium copper chlorophyllin (SCC).

5. The composition of any one of alternatives 1-4, wherein the absorbent compound is present in an amount ranging from 2 μmol to 30 μmol of absorbent compound per gram of textile material.

6. The composition of any one of alternatives 1-4, wherein the absorbent compound is present in an amount ranging from 50 to 500 nmol of absorbent compound per cm² of textile material.

7. The composition of any one of alternatives 1-6, wherein the absorbent compound is present in an amount of 1 gram to 20 grams.

8. The composition of any one of alternatives 1-7, wherein the toxic pollutant comprises an airborne pollutant.

9. The composition of any one of alternatives 1-8, wherein the toxic pollutant comprises a polycyclic aromatic hydrocarbon (PAH).

10. The composition of any one of alternatives 1-9, wherein the toxic pollutant comprises benzo[a]pyrene, benzo[e]pyrene, or combinations thereof.

11. The composition of any one of alternatives 1-10, wherein the composition is washable, and wherein the composition retains the absorbent compound after washing.

12. A method of capturing a toxic pollutant comprising:

providing a pollutant-absorbing composition of any one of alternatives 1-11; and

contacting the composition with a toxic pollutant.

13. The method of alternative 12, wherein the toxic pollutant comprises a polycyclic aromatic hydrocarbon (PAH).

14. The method of any one of alternatives 12-13, wherein the toxic pollutant is benzo[a]pyrene.

15. The method of any one of alternatives 12-14, wherein the composition binds to the toxic pollutant in an amount ranging from 0.2 to 10 nmol of pollutant.

16. The method of any one of alternatives 12-15, further comprising washing the pollutant-absorbing composition after capturing the toxic pollutant, thereby removing the toxic pollutant and regenerating the pollutant-absorbing composition.

17. A method of making a pollutant-absorbing composition of any one of alternatives 1-10, comprising:

providing a textile material; and

contacting the textile material with an absorbent compound.

18. The method of alternative 17, wherein the absorbent compound is present in an amount ranging from 0.1 to 1 mg/mL.

19. The method of any one of alternatives 17-18, wherein the contacting is performed for a period of time ranging from 1 to 20 hours at a temperature ranging from 45 to 70° C.

20. An article of clothing comprising the composition of any one of alternatives 1-11.

21. The article of clothing of alternative 20, wherein the article of clothing comprises a shirt or a facemask.

### BRIEF DESCRIPTION OF THE DRAWINGS

The drawings illustrate certain embodiments of the technology and are not limiting. For clarity and ease of illustration, the drawings are not made to scale and in some instances, various aspects may be shown exaggerated or enlarged to facilitate an understanding of particular embodiments.

FIG. 1 depicts a plot showing quantitative determination of amounts of an absorbent compound, sodium copper chlorophyllin (SCC) loaded into textile materials, including cotton (●) and rayon (▪).

FIG. 2 illustrates results of solid-phase microextraction (SPME) analysis of a pollutant-absorbing material after exposure to the toxic pollutant, benzo[e]pyrene. The signal indicating the presence of benzo[e]pyrene bound by the pollutant-absorbing material is circled.

FIGS. 3A-3B depict percent quantities of the toxic pollutant, benzo[e]pyrene, bound by pollutant-absorbing material having an absorbent compound, as compared to a control material lacking an absorbent compound. FIG. 3A depicts the percentage of bound pollutant for six separate trials. FIG. 3B depicts an average percentage of bound pollutant.

FIG. 4 depicts spectrophotometric curves for the absorbent compound, sodium copper chlorophyllin (SCC), depicting characteristic peaks at 407 nm and 629 nm. These peaks decrease upon binding of SCC to toxic pollutants.

FIGS. 5A-5B depict pollutant binding curves, showing a concentration of absorbent compound bound to pollutant per total absorbent compound as a function of pollutant concentration. FIG. 5A depicts an exemplary benzo[e]pyrene binding curve. FIG. 5B depicts an exemplary aflatoxin binding curve.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

It is to be understood that embodiments presented herein are by way of example and not by way of limitation. The intent of the following detailed description, although discussing exemplary embodiments, is to be construed to cover all modifications, alternatives, and equivalents of the embodiments as may fall within the spirit and scope of the present disclosure.

Exposure to pollutants represents a major social challenge. Pollutant exposure comes in a variety of forms, including respiratory exposure due to airborne pollutants or direct exposure due to soil or water pollution, for example. The inhalation of pollutants results in serious health issues, including, for example, cancers, heart disease, or asthma. Direct exposure to pollutants, such as skin contact with pollutants, also results in serious health issues, such as cancers.

Polycyclic aromatic hydrocarbons (PAHs) are planar aromatic compounds produced by combustion of carbon-based fuels or tobacco. Many PAHs are carcinogens, including benzo[a]pyrene, benzo[e]pyrene, benzo[b]fluoranthene, benzo[k]fluoranthene, benzo[g,h,i]pyrylene, benz[a]anthracene, dibenz[a,h]anthracene, or indeno[1,2,3-c,d]pyrene, acting by intercalating between base pairs of DNA and causing chemical damage and replication errors. PAHs are major carcinogens in tobacco smoke, and are found in roadside air and dust or in other locations in the vicinity of combustion of fossil fuels.

Embodiments of the compositions, devices, systems, and methods provided herein relate to the capture of toxic pollutants, such as PAHs, thereby reducing exposure to such pollutants, thereby reducing risks associated with exposure to PAH in second-hand tobacco smoke, or PAH in air polluted by combustion of fossil fuels, wood or other carbon-based fuels.

Benzo[a]pyrene, a well-known carcinogen, is generated by the combustion of organic material in engines, stoves, and factories. In the 1990s, studies began to link inhalation of benzo[a]pyrene and other polycyclic aromatic hydrocarbons (PAHs) to lung cancer (Denissenko, Science, 1996).

PAHs are thought to cause DNA mutation by interfering with the π-stacking of DNA base pairs. Sodium copper chlorophyllin (SCC) has been shown to decrease tumor formation after PAH exposure by preferential binding. This is explained by the relative affinity of PAH for the large π-system of porphyrin compared to the smaller π-system of DNA (Pietrzak, Biophys. Chem. 2006).

### Embodiments of the Pollutant-Absorbing Compositions

Embodiments provided herein relate to pollutant-absorbing compositions. In some embodiments, the compositions include a textile material and an absorbent compound. As used herein, textile material is used in its broad and ordinary contextual sense, and includes a flexible article having structural integrity resulting from interassociation of a network of a plurality of fibers, filaments, or strands, resulting from processes such as weaving, knitting, braiding, needling, spinning, crocheting, entangling, chemical coating, chemical impregnation, bonding, or felting. A textile material may be made of any substance, artificial or natural, that is capable of being integrated into an interassociated article, including, for example, animal substances such as hair (such as cashmere or wool), fur, skin (such as leather), or silk; plant substances such as cotton, flax, hemp, bamboo, cellulose, carbon, or activated carbon; mineral substances such as glass or metal fibers; or synthetic substances, such as polyester, nylon, rayon, carbon fibers, or any combination thereof.

As used herein, absorbent compound is used in its broad and ordinary contextual sense, and includes a compound that is capable of absorbing a pollutant. The term absorb, absorbing, or absorbent refers to an ability of a compound to capture or bind to a reagent, such as a pollutant. In some embodiments, the absorbent compound binds to or captures a pollutant. As used herein, the term bind, binding, or bound is used in its broad and ordinary contextual sense, and can include an attractive interaction between one molecule and another. Binding of a pollutant to an absorbent compound may include a non-covalent bond, covalent bond (including reversible or irreversible covalent bond), or other interaction between the molecules. The ratio of binding of pollutant to absorbent compound may include a ratio of 1:1, 1:2, 1:3, 1:4, 1:5, 1:6, 1:7, 1:8, 1:9, 1:10, 1:20, 1:30, 1:40, or 1:50 or in a ratio of 50:1, 40:1, 30:1, 20:1, 10:1, 9:1, 8:1, 7:1, 6:1, 5:1, 4:1, 3:1, or 2:1, or a ratio between a range defined by any two of the aforementioned values. Thus, in some embodiments, the composition is capable of capturing or absorbing a pollutant due to the binding of the pollutant to the absorbent compound that is integrated within the textile material.

In some embodiments, the absorbent compound is sodium copper chlorophyllin (SCC). In some embodiments, the absorbent compound is present in the textile material in an amount of greater than 1 μmol of absorbent compound per gram of textile material. For example, the absorbent compound may be present in the textile material in an amount of 1, 2, 3, 4, 5, 6, 7, 8, 9, 10, 20, 30, 40, 50, 60, 70, 80, 90, or 100 μmol of absorbent compound per gram of textile material, or in an amount within a range defined by any two of the aforementioned values. In some embodiments, the absorbent compound is present in the textile material in an amount of greater than 50 nmol of absorbent compound per cm² of textile material, such as, for example, 50, 60, 70, 80, 90, 100, 120, 140, 160, 180, 200, 220, 240, 260, 280, 300, 350, 400, 450, or 500 nmol of absorbent compound per cm² of textile material, or in an amount within a range defined by any two of the aforementioned values. In some embodiments, the absorbent compound is present in the textile material in a total quantity of at least than 1 gram, such as, for example, 1, 2, 3, 4, 5, 6, 7, 8, 9, 10, 11, 12, 13, 14, 15, 16, 17, 18, 19, or 20 grams of absorbent compound in the textile material, or in an amount within a range defined by any two of the aforementioned values.

In some embodiments, the absorbent compound is integrated into the textile material such that the absorbent material remains fixed within the absorbent material for extended periods of time, for example, for greater than one week, such as for a time period of 1, 2, 3, 4, or 5 weeks or 1, 2, 3, 4, 5, 6, 7, 8, 9, 10, 11, or 12 months, or 1, 2, 3, 4, 5, 6, 7, 8, 9, or 10 years, or for an amount of time within a range defined by any two of the aforementioned values. In some embodiments, the absorbent compound remains active and capable of capturing a pollutant for extended periods of time, for example, for greater than one week, such as for a time period of 1, 2, 3, 4, or 5 weeks or 1, 2, 3, 4, 5, 6, 7, 8, 9, 10, 11, or 12 months, or 1, 2, 3, 4, 5, 6, 7, 8, 9, or 10 years, or for an amount of time within a range defined by any two of the aforementioned values.

In some embodiments, following capture of a pollutant, the absorbent compound may be saturated, such that capture of further pollutant is not possible. Under such circumstances, in some embodiments, the absorbent compound may be renewed by removing the captured pollutants from the absorbent compound. Such removal of captured pollutant may take place, for example, by washing the textile material. In some embodiments, an absorbent compound remains fixed in the textile material and is renewed for further capturing of a pollutant following one or more washes of the textile material, for example, following 1, 2, 3, 4, 5, 6, 7, 8, 9, or 10 washes or more of the textile material.

In some embodiments, the pollutant is an airborne pollutant. In some embodiments, the pollutant is a toxic pollutant. A toxic pollutant includes any pollutant that exhibits toxic effects when exposed to a subject, for example, a substance that causes a disease or disorder in a subject. In some embodiments, the pollutant is a polycyclic aromatic hydrocarbon (PAH). In some embodiments, the pollutant is benzo[a]pyrene, benzo[e]pyrene, benzo[b]fluoranthene, benzo[k]fluoranthene, benzo[g,h,i]pyrylene, benz[a]anthracene, dibenz[a,h]anthracene, indeno[1,2,3-c,d]pyrene, aflatoxin, acenaphthene, acenaphthylene, anthracene, chrysene, coronene, fluorine, naphthalene, or pyrene.

Some embodiments provided herein relate to devices and systems that integrate a composition described herein, wherein the composition comprises a textile material and an absorbent compound. Such devices and systems may include, for example, the composition configured or prepared in a variety of configurations, such as clothing, such as a mask, a shirt, an overcoat, a hat, a linen, gauze, or gloves, or as an air filter. In some embodiments, the air filter may be integrated into a clothing, for example, an air filter integrated into a facemask. In some embodiments, the devices or systems are washable, for example, the devices or systems may be washed to remove captured pollutants. In some embodiments, the devices and systems are disposable.

Some embodiments provided herein relate to an article of clothing that includes any one or more of the compositions described herein. In some embodiments, the article of clothing includes overwear, underwear, liners, or accessory wear. In some embodiments, the article of clothing includes a shirt or a face mask.

### Embodiments of Methods of Making Pollutant-Absorbing Composition

Some embodiments provided herein related to methods of making and using pollutant-absorbing compositions described herein. Some embodiments of the methods of making the compositions include providing a textile material and contacting the textile material with an absorbent compound. In some embodiments, contacting a textile material with an absorbent compound includes soaking, spraying, coating, immersing, mixing, fabricating with, or otherwise integrating the absorbent compound into the textile material.

In some embodiments, the textile material is contacted with an absorbent material in an amount of at least 1 gram, such as, for example, 1, 2, 3, 4, 5, 6, 7, 8, 9, 10, 11, 12, 13, 14, 15, 16, 17, 18, 19, or 20 grams of absorbent compound, or in an amount within a range defined by any two of the aforementioned values. To achieve the aforementioned quantities of absorbent compound in the textile material, the textile material may be contacted with a solution of absorbent compound having a concentration of at least 0.1 mg/mL, for example, 0.1, 0.2, 0.3, 0.4, 0.5, 0.6, 0.7, 0.8, 0.9, 1, 2, 3, 4, 5, 6, 7, 8, 9, or 10 mg/mL, or a concentration within a range defined by any two of the aforementioned values. In some embodiments, the textile material is contacted with the absorbent compound for a period of time of at least 10 minutes, such as, for example, 10, 15, 30, 45, or 60 minutes, or 1, 2, 3, 4, 5, 10, 15, or 20 hours, or for an amount of time within a range defined by any two of the aforementioned values. In some embodiments, contacting is performed at a temperature ranging from 20 to 100° C., for example, 20, 30, 40, 50, 60, 70, 80, 90, or 100° C., or at a temperature within a range defined by any two of the aforementioned values. In some embodiments, following contacting, the composition is washed or rinsed. In some embodiments, following contacting, the composition is dried.

In some embodiments, the methods further include curing the composition. As used herein, curing is used in its broad and ordinary contextual sense, and includes a treatment intended to bind the absorbent compound with the textile material, such that the absorbent compound remains fixed within the textile material, but such that the absorbent compound retains the functionality of being capable of binding to and capturing pollutants. In some embodiments, curing may be thermal curing, chemical curing, catalyst curing, radiation curing, mechanical, or physical curing, or a combination thereof.

In some embodiments, a pollutant-absorbing composition may be analyzed following making of the composition to determine a quantity of absorbent compound in the textile material. Analysis of a quantity of absorbent material in the composition may be performed using standard analytical techniques, including, for example the use of inductively coupled mass spectrometry (ICP-MS) or reflectance spectroscopy, or other analytical instruments.

In some embodiments, analysis is performed by chemical digestion and/or microwave digestion. In some embodiments, chemical digestion includes contacting the composition with a chemical. In some embodiments, the chemical digestion includes contacting with an acid, such as nitric acid, or a peroxide, such as hydrogen peroxide, or both. In some embodiments, the composition is contacted with an acid in an amount ranging from 10% to 80%, such as 10, 15, 20, 30, 40, 50, 60, 70, or 80% or an amount of acid within a range defined by any two of the aforementioned values. In some embodiments, the composition is contacted with a peroxide in an amount ranging from 1% to 50%, such as 1, 2, 3, 4, 5, 10, 15, 20, 25, 30, 35, 40, 45, or 50% or in an amount of peroxide within a range defined by any two of the aforementioned values. In some embodiments, the composition is contacted with hydrogen peroxide and nitric acid.

In some embodiments, digestion is performed by microwave digestion. In some embodiments, microwave digestion is performed at a temperature ranging from 50° C. to 300° C., for example 50, 60, 70, 80, 90, 100, 110, 120, 130, 140, 150, 160, 170, 180, 190, 200, 210, 220, 230, 240, 250, 260, 270, 280, 290, or 300° C., or at a temperature within a range defined by any two of the aforementioned values. In some embodiments, microwave digestion is performed for a period of time of at least one minute, for example, 1, 2, 3, 4, 5, 6, 7, 8, 9, 10, 15, 20, 30, 40, 50, or 60 minutes, or for an amount of time within a range defined by any two of the aforementioned values. In some embodiments, microwave digestion takes place at a pressure of at least one bar, for example, 1, 2, 3, 4, 5, 10, 15, 20, 25, 30, 35, 40, 45, 50, 55, 60, 65, 70, 75, 80, 85, 90, 95, or 100 bar, or at a pressure within a range defined by any two of the aforementioned values. In some embodiments, microwave digestion is performed at a temperature of 180° C. at 30 bar for a period of 20 minutes.

In some embodiments, the absorbent compound is present in the textile material in an amount of greater than 1 μmol of absorbent compound per gram of textile material. For example, the absorbent compound may be present in the textile material in an amount of 1, 2, 3, 4, 5, 6, 7, 8, 9, 10, 20, 30, 40, 50, 60, 70, 80, 90, or 100 μmol of absorbent compound per gram of textile material, or in an amount within a range defined by any two of the aforementioned values. In some embodiments, the absorbent compound is present in the textile material in an amount of greater than 50 nmol of absorbent compound per cm² of textile material, such as, for example, 50, 60, 70, 80, 90, 100, 120, 140, 160, 180, 200, 220, 240, 260, 280, 300, 350, 400, 450, or 500 nmol of absorbent compound per cm² of textile material, or in an amount within a range defined by any two of the aforementioned values.

### Embodiments of Methods of Capturing a Pollutant Using the Pollutant-Absorbing Composition

Some embodiments provided herein relate to methods of using the pollutant-absorbing composition for capturing a pollutant. Some embodiments of the methods relate to methods of capturing a pollutant, absorbing a pollutant, reducing exposure of a subject to a pollutant, or reducing a quantity of pollutant in an airspace. In some embodiments, the methods include providing a pollutant-absorbing composition as described herein and contacting the pollutant-absorbing composition with a pollutant. By way of example, the pollutant-absorbing composition may be a shirt or a mask. In such embodiments, a user wears the shirt or mask, and over time, when present in an environment having airborne pollutants, the pollutants in the air contact the shirt or mask, and bind to the absorbent compound within the shirt or mask, thereby reducing exposure of the subject to pollutants. In some embodiments, the composition binds to pollutants in an amount of at least 0.1 nmol of pollutant, for example, 0.1, 0.2, 0.3, 0.4, 0.5, 0.6, 0.7, 0.8, 0.9, 1, 2, 3, 4, 5, 6, 7, 8, 9, 10, 15, 20, 25, 30, 35, 40, 45, or 50 nmol of pollutant.

In some embodiments, the methods include providing a composition, device, or system of any one of the embodiments described herein, and wearing the composition. For example, the pollutant-absorbing composition may be configured as a shirt and worn by a user. In some embodiments, when worn by a user, the absorbent compound and the pollutant that is captured by the absorbent compound does not interact with or otherwise associate with skin of the user, and thus provides no ill effect to the user. Similarly, where the pollutant-absorbing composition is configured as a mask, the absorbent compound and the pollutant that is captured by the absorbent compound does not interact with or otherwise associate with the respiratory tract of the user.

The methods disclosed herein comprise one or more steps or actions for achieving the described method. The method steps and/or actions may be interchanged with one another without departing from the scope of the present disclosure. In other words, unless a specific order of steps or actions is required for proper operation of the method that is being described, the order and/or use of specific steps and/or actions may be modified without departing from the scope of the present disclosure.

In the foregoing description, specific details are given to provide a thorough understanding of the examples. However, it will be understood by one of ordinary skill in the art that the examples may be practiced without these specific details.

Headings are included herein for reference and to aid in locating various sections. These headings are not intended to limit the scope of the concepts described with respect thereto. Such concepts may have applicability throughout the entire specification.

### EXAMPLES

Some aspects of the embodiments discussed above are disclosed in further detail in the following examples, which are not in any way intended to limit the scope of the present disclosure. Those in the art will appreciate that many other embodiments also fall within the scope of the invention, as it is described herein above and in the claims.

### Example 1

### Methods of Making Pollutant-Absorbing Composition

The following example demonstrates embodiments of a method of making pollutant-absorbing compositions.

A solution of absorbent compound was made by mixing 0.24 g of sodium copper chlorophyllin (SCC) in 400 mL H₂O at 80° C. for 30 minutes. The pollutant-absorbing composition was made by place a round piece of cloth (cotton or rayon) that was 12 cm in diameter was soaked in the solution for 1 hour. After prewashing, the cloth was allowed to dry overnight. The next day, a second absorbent compound solution was prepared and the cloth was soaked for 20 hours with continuous stirring, while maintaining a temperature of between 55-60° C. In order to stir without the cloth coming in direct physical contact with the stir bar, the cloth was placed on a spacer. The spacers were plastic frames with large open holes to allow for stirring of the whole container from the stir bar inside the frame. The cloth was then removed and immediately rinsed in cool water until the water ran clear. Finally, the cloth was allowed to dry overnight. Contacting the textile material with the absorbent compound is sometimes referred to herein as dyeing, because the compound dyed the textile material. Specifically, contacting the textile material with SCC resulted in dyeing the material a green color.

In addition to the procedure described above, silk and cotton material can be mixed with SCC. For the silk material, a solution of SCC at pH 8 mixed with NaCl between 70 and 90° C. results in a 75% uptake of SCC into the silk. For additional details, see Hou, Ind. Eng. Chem. Res. 2012. For the cotton material, cotton can be placed in a solution of NaOH and then padded with a chitosan solution. After this pretreatment, the cotton can be contacted with an SCC solution at 60° C. for 1.5 hours. For additional details, see Park, Fiber Polym. 2010. Without wishing to be bound by theory, SCC binds to the textile material through the carboxylic acids and not through it-bonds or interactions with the metal center. Other textile materials that may be used include flax and wool.

### Example 2

### Methods of Determining a Quantity of Absorbent Compound in the Textile Material

The following example demonstrates embodiments of a method of measuring an amount of absorbent compound integrated in the textile material.

After the textile material was contacted with an absorbent compound to make a pollutant-absorbing composition, as described in Example 1, the composition was analyzed to determine the quantity of absorbent compound that was integrated into the textile material. Inductively coupled plasma mass spectrometry (ICP-MS) was used to measure the loading of SCC on different types of fabric. Six 3×3 cm² samples of each cotton (C) and rayon (R) were gathered from four separate manufacturing batches.

The first set of samples were cut from dyed cloth having a dark green center and only minor dyeing around the edges. The second set were cut from fabric dyed to an uneven dark green. The third, fourth, fifth, and sixth sets were cut from swatches with a moderate and fairly even green color. In addition to these dyed samples, a piece of each cotton and rayon were cut to be used to match the digested fabric matrix. Descriptions of the cloth samples that were analyzed is outlined in Table 1.

TABLE 1
Sample, Origin, and Mass

| Sample | Origin | Mass (g) |
|---|---|---|
| C0 | Control (No SCC) | 0.122 |
| C1 | Dark center | 0.115 |
| C2 | Dark color, uneven | 0.115 |
| C3 | Moderate color, old cloth | 0.117 |
| C4a | Moderate color, new cloth | 0.114 |
| C4b | Moderate color, new cloth | 0.108 |
| C4c | Moderate color, new cloth | 0.108 |
| R0 | Control (No SCC) | 0.172 |
| R1 | Dark center | 0.173 |
| R2 | Dark color, uneven | 0.172 |
| R3 | Moderate color, old cloth | 0.157 |
| R4a | Moderate color, new | 0.162 |
| R4b | Moderate color, new | 0.164 |
| R4c | Moderate color, new | 0.162 |

Each of the 14 cloth pieces were then subjected to microwave digestion. Each sample was placed in an individual Teflon capsule with 8.00 mL 65% HNO₃ and 2.00 mL 30% H₂O₂. Capsules were placed in a Milestone Ethos microwave oven, which simultaneously increased both the temperature and pressure to 180° C. and 30 bar over 20 minutes. The oven held those conditions for 15 minutes before cooling to room temperature over a two-hour period. The resulting solution (about 10 mL) was then transferred to a 50 mL centrifuge tube and diluted to 20 mL using millipore water.

Using the control solutions (C0 and R0), sets of external standards were prepared for instrument calibration. To prepare the cotton standard, a 10 mL portion of the C0 solution was diluted to 100 mL in 2% nitric acid-millipore water. This dilution was then used to prepare standards containing copper at 0, 25, 50, 75, 100, and 125 ppb. A similar procedure was followed for rayon resulting in solutions at 0, 35, 70, 105, 140, and 175 ppb. 1 mL portions of the sample solutions were then diluted to 10 mL in 2% nitric acid-millipore water. This method was chosen to allow for close matrix matching of the standards and unknowns. The two sets of solutions as well as the unknowns were then analyzed in triplicate by an Agilent 7800 ICP-MS with He collision cell. ⁶⁵Cu was measured to avoid polyatomic interferences. The results are summarized in Table 2 at 95% confidence.

TABLE 2
Concentrations of SCC/gram and
SCC/cm² of fabric for each sample

| Sample | μmol_{SCC}/g_{cotton} | nmol_{SCC}/cm²_{cotton} |
|---|---|---|
| C1 | 12 ± 2 | 150 ± 30 |
| C2 | 26 ± 4 | 350 ± 50 |
| C3 | 6 ± 2 | 80 ± 20 |
| C4a | 5 ± 2 | 70 ± 20 |
| C4b | 4 ± 2 | 50 ± 20 |
| C4c | 5 ± 2 | 70 ± 20 |
| average | 5.2 ± 0.7 | 65 ± 8 |
| R1 | 11 ± 2 | 210 ± 40 |
| R2 | 20 ± 3 | 350 ± 60 |
| R3 | 9 ± 2 | 160 ± 30 |
| R4a | 8 ± 2 | 150 ± 30 |
| R4b | 8 ± 2 | 140 ± 30 |
| R4c | 9 ± 2 | 160 ± 30 |
| average | 8.4 ± 0.7 | 150 ± 10 |

The results confirm that the dark green samples (samples C1, R1, C2, and R2) bound significantly more SCC than the lighter samples (C3, R3, C4, and R4). In addition, the samples that came from a roughly homogeneous sample (C4 and R4) were dyed identically within 95% confidence. In comparing the amount of SCC bound to cotton and rayon, fabrics dyed with techniques 1 and 2 (C1, R1, C2, and R2) were not included in the average values due to the product is not reproducible or homogeneous. Averaging the remaining values (C3, R3, C4, and R4), the fabrics were loaded with 5.2±0.7 μmol SCC/g cotton and 8.4±0.7 μmol SCC/g rayon or 65±8 nmol SCC/cm² cotton and 150±10 nmol SCC/cm² rayon. Using the techniques of Example 1, rayon has a higher SCC dyeing efficiency.

In addition to the ICP-MS analysis outlined above, the samples were also analyzed using reflectance spectroscopy. Kubelka-Munk theory states that kF_{KM}=c=k(1−R∞)²/2R∞, where k is the molar absorption coefficient, F_{KM} is the Kubelka-Monk function, c is the chromophore concentration, and R∞ is the reflectance. By the above equation, chromophore concentration can be determined by reflection data. It is noted that k changes with each fabric, so concentrations cannot be independently determined. To overcome this issue, kF_{KM} was calibrated with the above ICP-MS experiment.

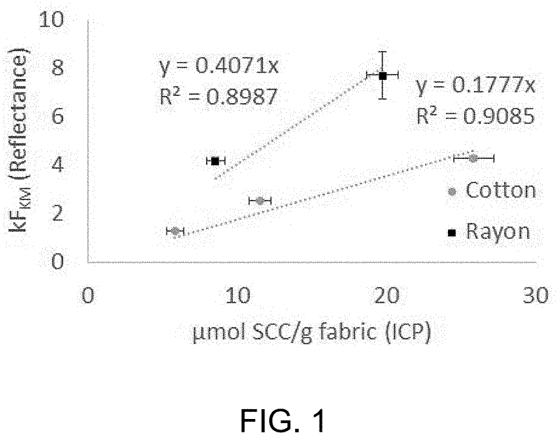

An Ocean Optics Flame Miniature Spectrometer and Ocean Optics DH-200-BAL lamp were used for reflectance measurements. Background spectra were subtracted from sample spectra of C1, R1, C2, R2, and C3, R3. Sample spectra were then compared to background subtracted reference spectra of undyed cotton and rayon. Reflectance data were then fit against ICP-MS data. The y-intercept was set at zero to match physical reality and one data point for rayon was discounted. Results are shown in FIG. 1, which depicts a plot of Kubelka-Monk function compared to SCC loading on both cotton (●) and rayon (▪).

The value of k varied significantly between cotton-bound SCC (177724 mol⁻¹) and rayon-bound SCC (407090 mol⁻¹). Simple error analysis indicates that the noise in the calibration was primarily due to the instrument noise from the reflectance spectrometer. This demonstrates that reflectance spectrometry can be used to quantify SCC loading into textile materials. The results of Examples 1 and 2 demonstrate methods of making textile materials having 5.2±0.7 μmol SCC/g cotton and 8.4±0.7 μmol SCC/g rayon.

### Example 3

### Capture of Toxic Pollutants Using a Pollutant-Absorbing Composition

The following example demonstrates embodiments of a method of capturing pollutants using a pollutant absorbing composition.

The pollutant-absorbing composition described in Example 1 and analyzed in Example 2 was tested for efficacy in binding to pollutants. Solid-phase microextraction (SPME) was used to determine the amount of benzo[e]pyrene that SCC-dyed cloth depleted from the atmosphere of a 20 mL vial. All vials were pretreated in an oven at high temperature overnight to prevent the septa from interfering with readings. A new and conditioned seven-micron polydimethylsiloxane (PDMS) fiber was used, and before each set of runs, the fiber was baked for 5 minutes. Experiments were carried out with multiple controls. Each set used four vials: vial 1 contained 40 μL of a 2.45×10⁻⁵ M benzo[a]pyrene solution; vial 2 contained a 2.45×10⁻⁵ M benzo[a]pyrene solution and a paperclip; vials 3 and 4 contained a 2.45×10⁻⁵ M benzo[a]pyrene solution, a paperclip, and a 2×2 cm² pollutant-absorbing composition of Example 1 held aloft with a clean paperclip (rinsed in acetone) and placed in the vial to avoid contact with the solution

The SPME method settings were as follows:

Injector, split/splitless: 280° C.

Carrier gas: He, splitless

Temperature program: hold at 40° C. for 2 mins, 40° C. to 280° C. at 25° C./min, hold for 6 mins

Incubation Temperature: 70° C.

Extraction Time: 30 mins

Desorption Time: 300 sec

Incubation Time: 35 mins

Agitator speed: 600 rpm

Vial Penetration (mm): 24 mm

Injection Penetration (mm): 45 mm

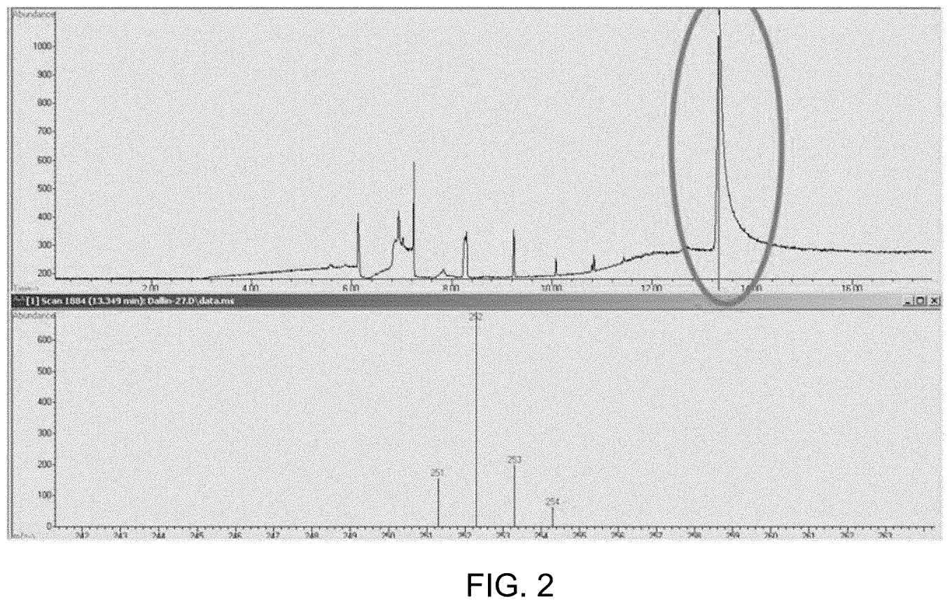

The peak corresponding to benzo[e]pyrene was identified by use of analyte spikes. The above method resulted in an average retention time of 13.3 minutes. A Hewlett Packard 6890 series gas chromatography mass spectrometer (GCMS) operated in SIM mode was used to observe the 251, 252, 253, and 254 m/z fragments. FIG. 2 shows the isotope pattern used to identify benzo[e]pyrene, with the benzo[e]pyrene peak circled with corresponding isotope pattern in the lower panel.

A total of six sets of runs were performed. Table 3 provides the results for the quantity of the pollutant that was absorbed on the pollutant-absorbing composition. A cloth without SCC was used as a control.

TABLE 3
Quantity of benzo[e]pyrene absorbed by SCC cloth

| Trial | Undyed (nmol_{pyrene}) | Dyed (nmol_{pyrene}) |
|---|---|---|
| 1 | 2.161 | 2.411 |
| 2 | 0.300 | 0.898 |
| 3 | 0.387 | 0.846 |
| 4 | 0.872 | 0.895 |
| 5 | 0.535 | 0.797 |
| 6 | 0.085 | 0.401 |

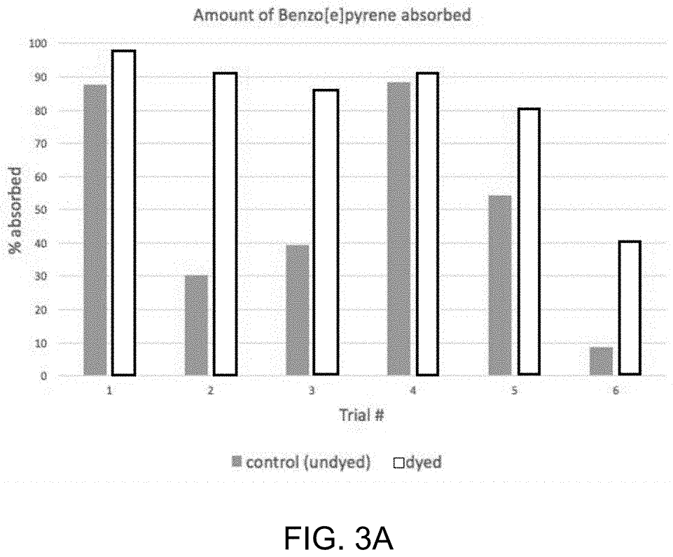

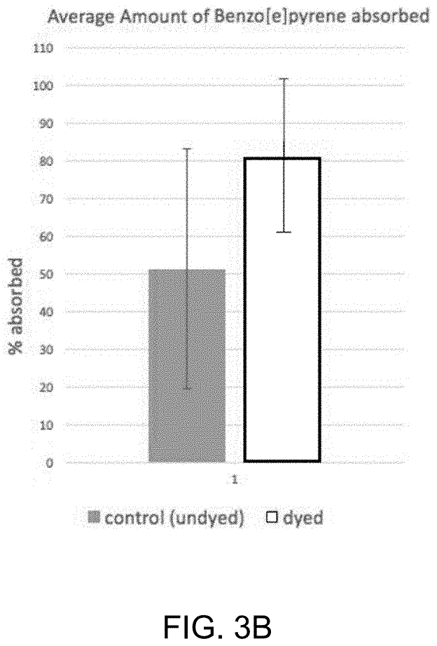

FIGS. 3A and 3B graphically depict the results from Table 3, represented in percent of benzo[e]pyrene absorbed. As shown, in each trial, the dyed cloth absorbed more than the control cloth.

To ensure accurate data collection and calculations, SPME fluctuations were minimized to lower the standard deviations. Method reliability was improved by baking the fiber for 5 minutes between each run. This ensured that the fiber was clean and absorbs analyte with consistent affinity. This example demonstrates that on average, SCC dyed cloth absorbs 44% (0.318 nmol) more benzo[e]pyrene than undyed cloth.

### Example 4

### Washfastness of Pollutant-Absorbing Compositions

The following example demonstrates embodiments of methods of washing the pollutant-absorbing compositions described in Example 1, and retaining the absorbent compounds.

Having established that SCC can be bound to cloth (Examples 1 and 2) and that SCC dyed cloth was active in removing benzo[e]pyrene from a sealed environment (Example 3), the pollutant-absorbing composition was analyzed to determine whether it is capable of being regenerated by washing the material. SCC that has bound a pollutant can be regenerated.

Washfastness was determined by reflectance spectroscopy. Dyed cotton was analyzed and then washed with commercially available laundry detergent at a local laundromat with a load of personal clothing Based on reflectance data, 10±5% of the original SCC content was lost.

The same SPME protocol described in Example 3 was used to test the amount of airborne carcinogen a piece of SCC dyed cloth can absorb after being exposed to a carcinogen and washed. The experiments used four samples: an undyed cotton control, a dyed cotton negative control, a dyed and incubated positive control, and a dyed, incubated, and washed sample. Incubation was carried out by suspending a piece of dyed cloth in a sealed container with about 0.5 mg of solid benzo[e]pyrene at room temperature for 24 hours. Washing was carried out as outlined above.

As shown in Table 4, the washing restored cotton's ability to bind benzo[e]pyrene despite some loss of SCC from washing.

TABLE 4
Normalized value of benzo[e]pyrene peak area

| Sample | Signal |
|---|---|
| Undyed | 1 |
| Dyed | 0.896 |
| Dyed, incubated | 1.334 |
| Dyed, incubated, washed | 1.205 |

Despite some loss of SCC that is removed during laundering, washing releases carcinogen bound SCC, allowing the cloth to be reusable.

### Example 5

### Determination of Binding Affinity of Absorbent Compounds to Pollutants

The following example demonstrates embodiments of methods of measuring binding affinities of absorbent compounds to pollutants.

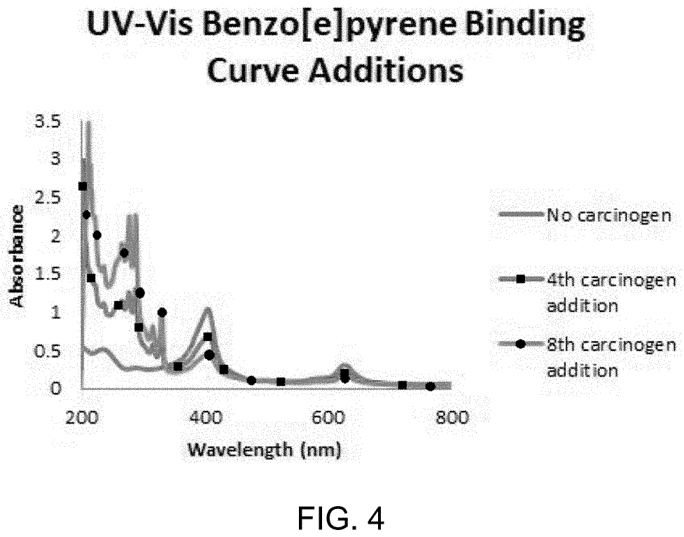

The affinity of SCC for various carcinogens is an important parameter to understand in considering binding carcinogens to clothing Tight bonding is required to avoid desorption from the clothing and absorption into the body. K_{d} values were determined by UV-vis spectroscopy. SCC in methanol has notable absorption peaks at 407 nm and 629 nm. As shown in FIG. 4, these peaks at 407 nm and 629 nm decrease upon binding of SCC to benzo[e]pyrene. Comparison of the values of these peaks serves as a measure of how much SCC has been bound as a function of carcinogen concentration. All tests were run on a UV-vis instrument in methanol. The peak at 407 nm was tracked due to its higher absorbance (Breinholt, Chem. Res. Toxicol. 1995).

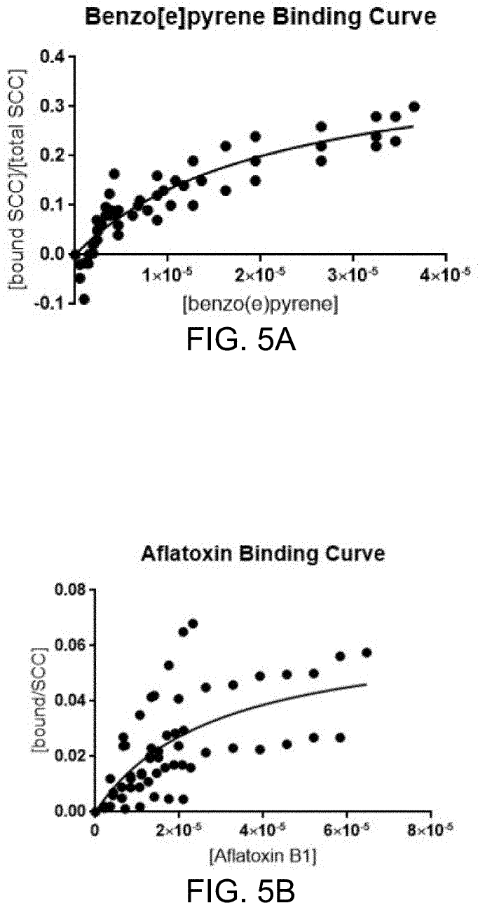

The value of K_{d} for benzo[e]pyrene was determined by adding a consistent volume of a benzo[e]pyrene-methanol solution to a SCC-methanol solution every 2 minutes until between a 1:1 and 1:2 mol ratio of SCC:benzo[e]pyrene was reached. The maximum absorbance at 407 nm was collected from every addition and baseline corrected. Data from all runs were uploaded to GraphPad Prism 7 which calculated K_{d}=2.1×10⁻⁵±5×10⁻⁶ and b max=0.41±0.05 (FIG. 5A). Aflatoxin B binding curve data was collected by similar manner, with K_{d}=2.9×10⁻⁵±1×10⁻⁵ and b max=0.067±0.015 (FIG. 5B).

Without wishing to be bound by theory, there are multiple reactions when a carcinogen binds to SCC. The first π-π interactions with aflatoxin and SCC. Owing to the low bₘₐₓ, a second set of π-π interactions with the carcinogen and another SCC molecule create a chain of bound molecules. Additional chemical interactions between SCC and the carcinogen also occur.

In at least some of the previously described embodiments, one or more elements used in an embodiment can interchangeably be used in another embodiment unless such a replacement is not technically feasible. It will be appreciated by those skilled in the art that various other omissions, additions and modifications may be made to the methods and structures described above without departing from the scope of the claimed subject matter. All such modifications and changes are intended to fall within the scope of the subject matter, as defined by the appended claims.

With respect to the use of substantially any plural or singular terms herein, those having skill in the art can translate from the plural to the singular or from the singular to the plural as is appropriate to the context or application. The various singular/plural permutations may be expressly set forth herein for sake of clarity.

The embodiments illustratively described herein suitably may be practiced in the absence of any element(s) not specifically disclosed herein. Thus, for example, in each instance herein any of the terms “comprising,” “consisting essentially of,” and “consisting of” may be replaced with either of the other two terms. The terms and expressions which have been employed are used as terms of description and not of limitation, and use of such terms and expressions do not exclude any equivalents of the features shown and described or portions thereof, and various modifications are possible within the scope of the technology claimed. The term “a” or “an” can refer to one of or a plurality of the elements it modifies (e.g., “a reagent” can mean one or more reagents) unless it is contextually clear either one of the elements or more than one of the elements is described. The term “about” as used herein refers to a value within 10% of the underlying parameter (i.e., plus or minus 10%), and use of the term “about” at the beginning of a string of values modifies each of the values (i.e., “about 1, 2 and 3” refers to about 1, about 2 and about 3). For example, a weight of “about 100 grams” can include weights between 90 grams and 110 grams. Further, when a listing of values is described herein (e.g., about 50%, 60%, 70%, 80%, 85% or 86%) the listing includes all intermediate and fractional values thereof (e.g., 54%, 85.4%). Thus, it should be understood that although the present technology has been specifically disclosed by representative embodiments and optional features, modification and variation of the concepts herein disclosed may be resorted to by those skilled in the art, and such modifications and variations are considered within the scope of the embodiments.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible sub-ranges and combinations of sub-ranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into sub-ranges as discussed above. Finally, as will be understood by one skilled in the art, a range includes each individual member. Thus, for example, a group having 1-3 articles refers to groups having 1, 2, or 3 articles. Similarly, a group having 1-5 articles refers to groups having 1, 2, 3, 4, or 5 articles, and so forth.

The entirety of each patent, patent application, publication and document referenced herein hereby is incorporated by reference. Citation of the above patents, patent applications, publications and documents is not an admission that any of the foregoing is pertinent prior art, nor does it constitute any admission as to the contents or date of these publications or documents. Their citation is not an indication of a search for relevant disclosures. All statements regarding the date(s) or contents of the documents is based on available information and is not an admission as to their accuracy or correctness.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A pollutant-absorbing composition comprising a textile material and an absorbent compound, wherein the composition captures a toxic pollutant.

2. The composition of claim 1, wherein the textile material comprises cotton, rayon, silk, flax, hemp, bamboo, polyester, nylon, or wool, or a combination thereof.

3. The composition of claim 1, wherein the textile material is configured as a mask, a shirt, an overcoat, a hat, a linen, gloves, or an air filter.

4. The composition of claim 1, wherein the absorbent compound is sodium copper chlorophyllin (SCC).

5. The composition of claim 1, wherein the absorbent compound is present in an amount ranging from 2 μmol to 30 μmol of absorbent compound per gram of textile material.

6. The composition of claim 1, wherein the absorbent compound is present in an amount ranging from 50 to 500 nmol of absorbent compound per cm² of textile material.

7. The composition of claim 1, wherein the absorbent compound is present in an amount of 1 gram to 20 grams.

8. The composition of claim 1, wherein the toxic pollutant comprises an airborne pollutant.

9. The composition of claim 1, wherein the toxic pollutant comprises a polycyclic aromatic hydrocarbon (PAH).

10. The composition of claim 1, wherein the toxic pollutant comprises benzo[a]pyrene, benzo[e]pyrene, or combinations thereof.

11. The composition of claim 1, wherein the composition is washable, and wherein the composition retains the absorbent compound after washing.

12. A method of capturing a toxic pollutant comprising:
providing a pollutant-absorbing composition, wherein the composition comprises:
a textile material; and
an absorbent compound, wherein the composition is configured to capture a toxic pollutant; and
contacting the composition with a toxic pollutant.

13. The method of claim 12, wherein the toxic pollutant comprises a polycyclic aromatic hydrocarbon (PAH).

14. The method of claim 12, wherein the toxic pollutant is benzo[a]pyrene.

15. The method of claim 12, wherein the composition binds to the toxic pollutant in an amount ranging from 0.2 to 10 nmol of pollutant.

16. The method of claim 12, further comprising washing the pollutant-absorbing composition after capturing the toxic pollutant, thereby removing the toxic pollutant and regenerating the pollutant-absorbing composition.

17. A method of making a pollutant-absorbing composition, the method comprising:
providing the textile material; and
contacting the textile material with an absorbent compound.

18. The method of claim 17, wherein the absorbent compound is present in an amount ranging from 0.1 to 1 mg/mL.

19. The method of claim 17, wherein the contacting is performed for a period of time ranging from 1 to 20 hours at a temperature ranging from 45 to 70° C.

20. An article of clothing comprising a composition comprising:
a textile material; and
an absorbent compound, wherein the composition is configured to capture a toxic pollutant.

21. The article of clothing of claim 20, wherein the article of clothing comprises a shirt or a facemask.
